(19) United States
(12) Patent Application Publication
(10) Pub. No.: US 2023/0297861 A1
(43) Pub. Date: Sep. 21, 2023

(54) GRAPH RECOMMENDATIONS FOR OPTIMAL MODEL CONFIGURATIONS

(71) Applicant: Oracle International Corporation, Redwood Shores, CA (US)

(72) Inventors: Chirag Ahuja, Delhi (IN); Vikas Rakesh Upadhyay, Seattle, WA (US); Syed Fahad Allam Shah, Washougal, WA (US); Samik Raychaudhuri, Bangalore (IN); Hariharan Balasubramanian, Redmond, WA (US); Michal Piotr Prussak, Kirkland, WA (US); Shwan Ashrafi, Bellevue, WA (US)

(73) Assignee: Oracle International Corporation, Redwood Shores, CA (US)

(21) Appl. No.: 17/696,685

(22) Filed: Mar. 16, 2022

(51) Int. Cl. G06N 5/04; G06F 16/901

(52) U.S. Cl. CPC G06N 5/046; G06F 16/9024; G06N 20/00

(57) ABSTRACT

A computing device may access a graph comprising one or more model nodes, one or more dataset nodes, and one or more edges, the model nodes having a plurality of features. The device may add one or more test dataset nodes and test edges to the graph. The device may perform a series of iterative steps until a threshold is reached. For each iterative step: a selection probability is determined, the selection probability being based at least in part on a plurality of selection criteria; a particular model node is selected, the particular model node being selected based at least in part on the selection probability; the selection criteria is updated based at least in part on the particular model; and the plurality of features are updated based at least in part on the particular model. The device may provide the particular model node selected in the last iterative step.

### BACKGROUND

Selecting hyperparameters for a machine learning model can be time consuming and computationally demanding. For example, selecting optimal hyperparameters for a model with close to one hundred parameters can involve fitting thousands of models over several days. Additionally, current model tuning techniques can be difficult to scale or parallelize. Thus, challenges exist in hyperparameter selection for machine learning module tuning.

### BRIEF SUMMARY

Techniques are provided for recommending a model and hyperparameters for a given dataset.

In an embodiment, a graph can be accessed by a computing device. The graph can comprise one or more model nodes, one or more dataset nodes and one or more edges. The model nodes can have at least one of a plurality of features or a plurality of weights. One or more test dataset nodes and one or more test edges can be added to the graph by the computing device. Until a threshold is reached a computing device can perform a series of iterative steps. For each step: a computing device can determine a selection probability for each model node. The selection probability can be based at least in part on a plurality of selection criteria. For each iterative step: a particular model node can be selected by the computing device. The particular model node can be selected based at least in part on the selection probability. For each iterative step: the selection criteria can be updated by the computing device. The updated selection criteria can be based at least in part on the particular model. For each iterative step: the plurality of features or the plurality of weights can be updated based at least in part on the particular model. The selected particular model node for the last iterative step in the series of iterative steps can be provided by the computing device for presentation.

In one general aspect the plurality of features can comprise a plurality of features.

In one general aspect a model node, from the one or more model nodes, and a first dataset node, from the one or more dataset nodes, can be connected by a model edge, from the one or more edges. The model node and the first dataset node can be connected if the dataset has been evaluated by the model.

In one general aspect a dataset edge, from the one or more edges, connecting the first dataset node and a second dataset node, from the one or more dataset nodes, has a similarity weight. The similarity weight can indicate a similarity between the first dataset node and the second dataset node.

In one general aspect adding one or more test edges further comprises determining the similarity weight for the one or more test edges.

In one general aspect the model edge has a selection weight. The selection criteria can be based at least in part on the selection weight.

In one general aspect the threshold can be at least one of a time period, a central processing unit (CPU) allocation, or a random access memory (RAM) allocation.

One general aspect includes a computer-readable storage medium storing a set of instructions that when executed by one or more processors of a recommendation system computing device, cause the one or more processors to perform instructions comprising: accessing a graph comprising one or more model nodes, one or more dataset nodes, and one or more edges. The one or more model nodes can have at least one of a plurality of features or a plurality of weights. The instructions include adding one or more test dataset nodes and one or more test edges to the graph. The instructions include performing a series of iterative steps until a threshold is reached. The instructions include, for each iterative step, determining a selection probability for each model node. The selection probability can be based at least in part on a plurality of selection criteria. The instructions include, for each step, selecting a particular model node. The particular model node can be selected based at least in part on the selection probability. The instructions include, for each step, updating the selection criteria based at least in part on the particular model. The instructions include, for each step, updating at least one of the plurality of features or the plurality of weights based at least in part on the particular model. The instructions include providing the selected particular model node for the last iterative step in the series of iterative steps for presentation.

One general aspect includes a recommendation system with a memory configured to store a plurality of instructions and one or more processors configured to access the memory, and to execute the plurality of instructions to at least: access a graph comprising one or more model nodes, one or more dataset nodes, and one or more edges. The one or more model nodes can have at least one of a plurality of features or a plurality of weights. The system is also configured to add one or more test dataset nodes and one or more test edges to the graph. The system is also configured to perform a series of iterative steps until a threshold is reached. For each iterative step the system is configured to determine a selection probability for each model node. The selection probability can be based at least in part on a plurality of selection criteria. For each iterative step the system is configured to select a particular model node. The particular model node can be selected based at least in part on the selection probability. For each iterative step the system is configured to update the selection criteria based at least in part on the particular model. For each iterative step the system is configured to update at least one of the plurality of features or the plurality of weights based at least in part on the particular model. The system is configured to provide the selected particular model node for the last iterative step in the series of iterative steps for presentation.

### BRIEF DESCRIPTION OF THE DRAWINGS

FIG. 1 shows a depiction of a grid search in a two-dimensional hyperparameter space.

FIG. 2 shows a depiction of a random search in a two-dimensional hyperparameter space.

FIG. 3 shows a depiction of a Bayesian search in a two-dimensional hyperparameter space.

FIG. 4 shows a simplified graph according to an embodiment.

FIG. 5 shows a process for generating a graph according to an embodiment.

FIG. 6 is a simplified graph with a test dataset node according to an embodiment.

FIG. 7 is a process for recommending a model to evaluate a dataset according to an embodiment.

FIG. 8 shows a method for recommending a model to evaluate a dataset according to an embodiment.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure provide techniques for recommending a model and hyperparameters for a given dataset. A hyperparameter can be a parameter that controls the learning process for turning a learning algorithm into a trained model. Hyperparameters can be set before the learning process begins while other types of model parameters can be learned from data during training. The number and type of hyperparameters can vary between learning algorithms with some simple algorithms having no hyperparameters, e.g., ordinary least squares (OLS) regression, while complex algorithms can have tens or hundreds of hyperparameters.

Hyperparameter optimization, or hyperparameter tuning, is a process of finding an optimal hyperparameter set for a learning algorithm (e.g., an algorithm that can be trained to produce a machine learning model). An optimal hyperparameter set can be the hyperparameters that produce an optimal model from the trained learning algorithm. An optimal model is one that results in an optimized value for an objective function. When the objective function is a loss function (e.g., cost function) the optimized value may be a minimum value for the function for given data. If the objective function is a utility function (e.g., reward function, profit function, fitness function, etc.) the optimized value can be a maximum value for function for given data.

The hyperparameter space can be a volume where each dimension represents a hyperparameter. For instance, a two-dimensional hyperparameter space can be a rectangle where each axis represents the possible values for a hyperparameter. The hyperparameter space can be a subset of the possible hyperparameter values. The hyperparameter space can be manually defined by assigning a range of values for each hyperparameter.

Grid search is a brute force method that can be used to approximate an optimal hyperparameter set in a hyperparameter space. To systematically search the hyperparameter space, each hyperparameter can be sampled at regular intervals. The hyperparameter samples can be combined and the different permutations of samples can be tested. For example, in a two-dimensional hyperparameter space 10 samples can be taken from each hyperparameter and 100 permutations can be tested. If plotted in the hyperparameter space, the samples appear as a grid of points with each point representing a combination of hyperparameter values. The objective function can be evaluated using the hyperparameter values from each point in the grid. Once each point in the grid has been evaluated, the optimal hyperparameter set can be approximated by selecting the hyperparameter set that produced the smallest loss function value or the largest utility function value.

An optimal hyperparameter set can also be approximated through a random search. A random search can include evaluating the objective function using a random hyperparameter set from the hyperparameter space. A random search can be significantly faster than a grid search, but a random search is not guaranteed to converge. Compared to a grid search, a random search can evaluate a larger number of individual hyperparameter values for each hyperparameter. For instance, 100 different hyperparameter combinations can be evaluated for a two dimensional hyperparameter space. Using a grid search 100 permutations may only mean that 10 different hyperparameter values (e.g., samples) are tested for each hyperparameter. In contrast, a random search may test 100 distinct hyperparameter values for each hyperparameter.

Bayesian optimization is an iterative process that can be used to approximate an optimal hyperparameter set for a given hyperparameter space. In Bayesian optimization, a probability model is created for the objective function. In a first iteration, the probability model, or surrogate, is then used to select promising hyperparameter values. The objective function can be evaluated using the promising hyperparameter values identified using the probability model. The results from evaluating the objective function can then be used to update the probability model. The updated probability model can be used to identify promising hyperparameter values in the next iteration. Through this iterative process, the promising hyperparameter values can be refined. Bayesian optimization, however, can be prone to over-fitting. Additionally, because Bayesian optimization is sequential it can be difficult to optimize for parallel computing.

A problem with the hyperparameter selection methods mentioned above is that the entire method may need to be restarted for each new algorithm or dataset. A hyperparameter search can be time consuming and a method that allows previous hyperparameter searches to inform future searches is desirable. The proposed method involves creating a graph neural network where the graph's nodes can represent trained machine learning models or datasets. Edges can connect the model nodes with datasets that the model has evaluated. Edges can also connect different datasets, and the edges can contain a weight indicating the similarity of the datasets. Selecting a model, with hyperparameters, can be treated as a contextual bandit problem that recommends a model, with hyperparameters, for a new dataset based on that model's performance evaluating similar datasets.

A contextual bandit can be a type of reinforcement learning where current decisions are optimized based at least in part on the results of previous decisions. A contextual bandit model can select from a number of possible decisions. After making a decision, the contextual bandit model can observe the results of the decision. Each decision is assigned a utility, or reward, and the model's decision making is updated to incentivize decisions that maximize utility. In contrast to one armed bandit or multi armed bandit models, a contextual bandit model considers context when using a past decisions to formulate new decisions.

For example, a contextual bandit model can be used to provide internet search results to a patent examiner who likes to paint in her spare time. In this case, the context can be the time and day. During the work hours a search for “art” may return patent prior art related results. However, a weekend search for “art” by the same examiner may return painting related results. The different context can be based at least in part on the links that the examiner has selected in the past during the different time periods. Because the examiner was more likely to select work related prior art links during the work week, the contextual bandit model presents work related results when the time and day (e.g., context) indicates the examiner is working.

In an illustrative example, a researcher is trying to design a classification model for classifying patients based on their dental records. The researcher has a dental record dataset but has not yet selected a model. The researcher would like a suggested model and a set of hyperparameters that can be used as a starting point for training the classification model. To obtain a suggestion, the researcher accesses a graph database containing nodes representing models and datasets. The model nodes contain hyperparameters and the model nodes are connected by edges to datasets that the model has been used to evaluate. The dataset nodes are connected by edges representing the similarity of the datasets. The context for the contextual bandit can be the similarity of the test dataset to other datasets in the graph database. A graph neural network can be used to learn the test dataset's embeddings. The embeddings can be used as a context vector to find similar datasets in the graph database. The hyperparameters can be copied from the test dataset to the similar datasets.

Continuing the example, the researcher can add a test node to the graph database. The test node represents the dental record dataset and the node includes features describing the dataset. After adding the test node to the graph database, the similarity between the test node and the existing dataset nodes is calculated. In this case, the dental record dataset is similar to a dataset containing medical records but the dental record dataset has little similarity to a dataset of movie reviews. The calculated similarity is used to create edges between the test node and the existing dataset nodes where the edges contain a weight showing the similarity of the connected datasets. Once the test node has been added to the graph database, the graph's features can be observed.

Containing the example, once the graph database with the test dataset have been created, a model node representing a model and hyperparameters is selected through a series of iterative steps. A model, with hyperparameters, is selected for each iterative step using a selection probability. The selected model is used to update the graphs features as well as the selection probability. The iterative steps continue until a timer runs out. The model selected in the last step is presented to the researcher using a user interface. The researcher can then fine-tune the selected model to produce a dental record classification model without the need to start a hyperparameter search from scratch.

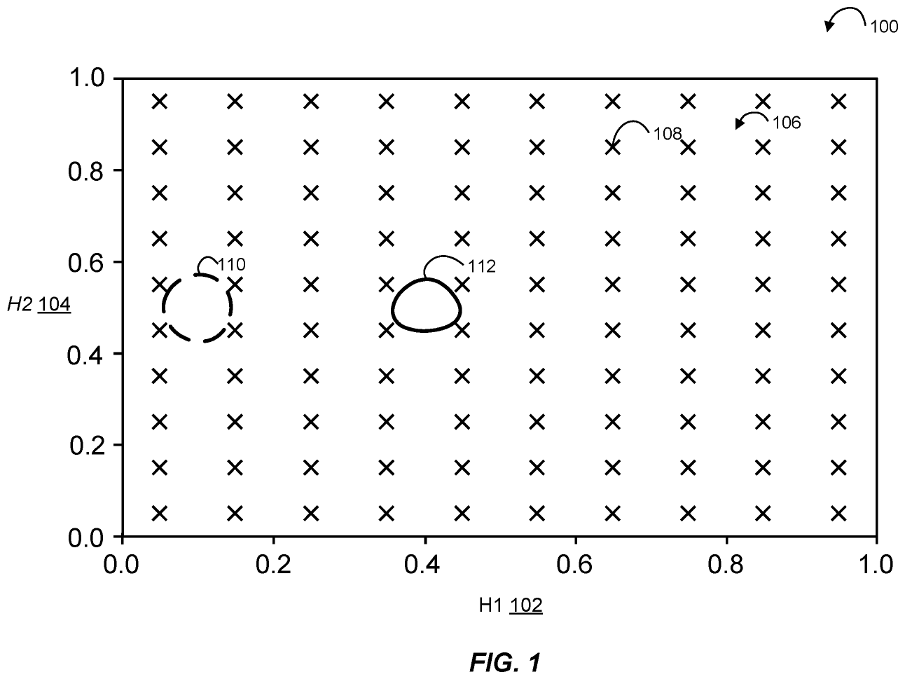

FIG. 1 is a simplified graph 100 showing a grid search for hyperparameters in a two-dimensional hyperparameter space. H1 102 represents a first hyperparameter with a range of possible values from 0.0 to 1.0. H2 104 is a second hyperparameter that also has a range of values from 0.0 to 1.0. H1 102 and H2 104 can form the axes of a two dimensional hyperparameter space 106. Each X within hyperparameter space 106 can represent a combination of H1 102 and H2 104 values. For instance, X 108 can represent a set of hyperparameters where H1 102 is 0.65 and H2 104 is 0.75. The dashed line circle 110 can represent an area in hyperparameter space 106 with poor hyperparameter combinations. The solid line circle 112 can represent an area in hyperparameter space 106 with strong hyperparameter combinations.

During a grid search, a number of values are selected for each hyperparameter. In this case 10 different hyperparameter values are chosen for both H1 102 and H2 104. However, the number of selected values can be different for each hyperparameter. The values can be selected at regular intervals and, in this case, the selected values are chosen at intervals of 0.1. The objective function can be evaluated with permutation of the selected values. When plotted on the graph the permutations, e.g., X 108, can appear as a grid that evenly covers hyperparameter space 106.

A grid search can systematically examine a hyperparameter space. However, a limitation of a grid search for hyperparameter values is that a relatively small number of individual hyperparameter values are tested compared to other search techniques. For instance, the 100 tests conducted as part of the grid search shown in FIG. 1 represent only 10 individual values for H1 102 and H2 104. A similarly sized random search could evaluate an objective function with 100 unique values for each hyperparameter because the tested values are selected at random.

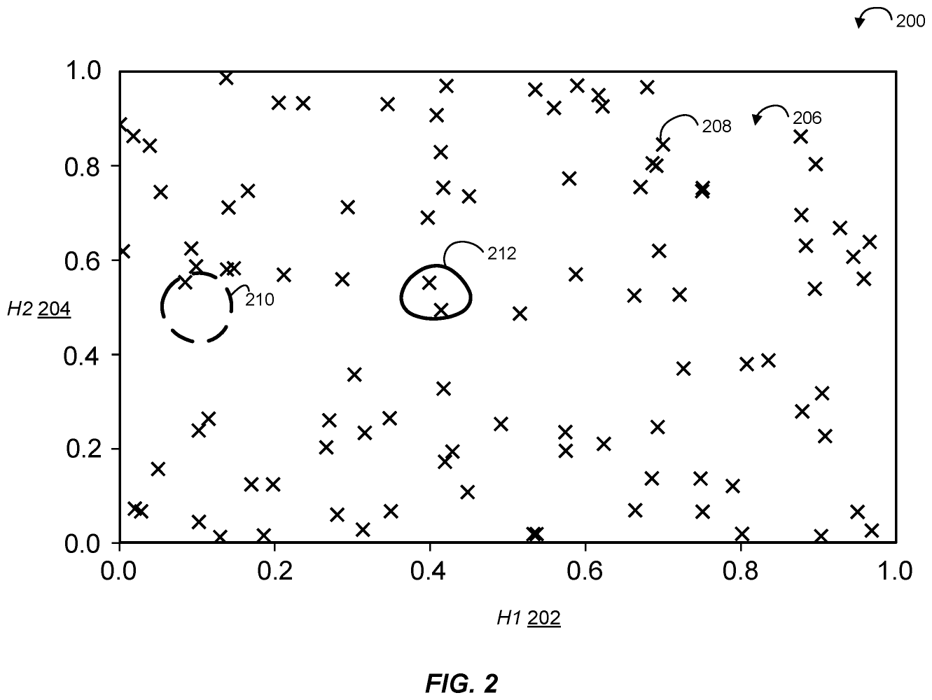

FIG. 2 shows a simplified graph 200 showing a random search for hyperparameters in a two dimensional hyperparameter space. The simplified graph 200 depicts a first hyperparameter H1 202, a second hyperparameter H2 204, and a two dimensional hyperparameter space 206 that are similar to the hyperparameters and two-dimensional hyperparameter space described in relation to simplified graph 100.

During a random search, hyperparameter combinations are selected at random and the hyperparameter combinations, e.g., X 208, can be used to evaluate the objective function. In contrast to a grid search, a large number of individual hyperparameter values can be evaluated. Dashed line circle 210 represents areas with promising hyperparameter combinations, while solid line circle 212 represents an area with poor hyperparameter combinations. While a large number of hyperparameter combinations can be tested, because the combinations are selected at random the method is not guaranteed to converge on an optimal solution.

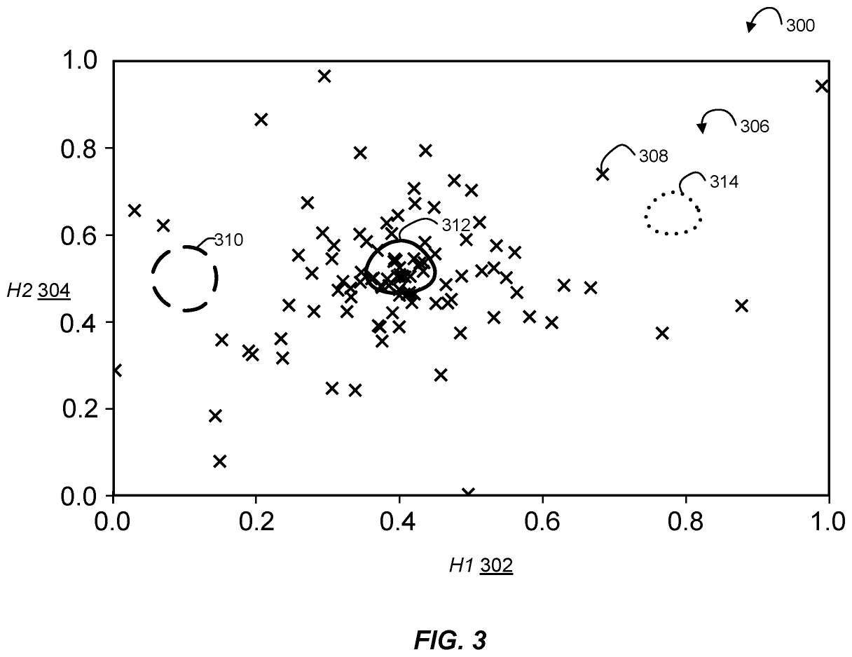

FIG. 3 shows a simplified graph 300 showing a Bayesian search for hyperparameters in a two dimensional hyperparameter space. The simplified graph 300 depicts a first hyperparameter H1 302, a second hyperparameter H2 304, and a two dimensional hyperparameter space 306 that are similar to the hyperparameters and two-dimensional hyperparameter space described in relation to simplified graphs 100 and 200.

During the Bayesian search, a hyperparameter combination, e.g., X 308, is selected using a probability model, or surrogate. The selected hyperparameters can be used to evaluate the objective function for the algorithm being trained. The results of the evaluation are used to update the probability model and the updated probability model can be used to select a new hyperparameter combination. This process can continue iteratively until an acceptable hyperparameter combination is identified.

A concern with Bayesian hyperparameter search is that the search may converge on a hyperparameter set that is not the optimized hyperparameter set. The graph can contain an area with poor hyperparameter values, indicated by dashed line circle 310, and an area with promising hyperparameter values, indicated by solid line circle 312. The simplified graph 300 can also include a second area with promising values that contains the optimized hyperparameter values (e.g., dotted line circle 314). Because a Bayesian search iteratively optimizes based on an initial hyperparameter combination, the search can converge on one of the areas with promising hyperparameter values (e.g., solid line circle 312) to the exclusion of other areas with promising hyperparameter values such as dotted line circle 314.

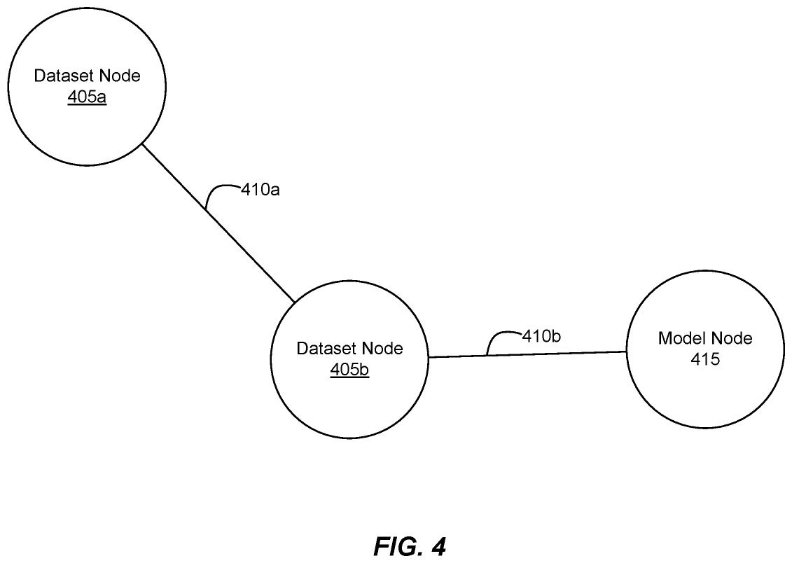

FIG. 4 shows a simplified graph 400 according to an embodiment. The graph can include dataset nodes 405a-b. Dataset nodes 405a-b can be nodes, or vertexes, representing datasets (e.g., M3, M4, M5, etc.). Features describing the dataset can be included in the dataset nodes 405a-b. The features can include the size of the data in the dataset, the domain of the data in the dataset, and/or latent or statistical features (e.g., mean, mode, Fourier transform coefficients, wavelet transform coefficients, change points, Seasonal Trend decomposition using Loess (STL), etc.) An edge 410a can connect two dataset nodes 405a-b. The edge connecting two dataset nodes 405a-b can include a metric (e.g., weight) indicating a similarity between the connected datasets.

Simplified graph 400 can include model nodes. Model nodes, such as model node 415, can represent a model. Features describing the model can be included in model node 415. The features can include the model type (e.g., parametric models, non-parametric models, discriminative models, generative models, etc.), the number of model parameters, the model's hyperparameters, the model family (e.g., linear, tree, neural network, etc.), etc.

Model nodes and dataset nodes can be connected by an edge. For example, model node 415 can be connected to dataset node 405b by an edge 410b. Edge 410b can connect model node 415 to dataset node 405b if the model represented by model node 415 was used to evaluate the dataset represented by dataset node 405b. Edge 410b can include a weight, or metric, representing the performance of the model, represented by the model node 415, in evaluating the dataset, represented by the dataset node 405b. The weight can be the root-mean-square deviation (RMSD) or root-mean-square error (RMSE). In some circumstances, a model node and a dataset node are not connected by an edge if the model node has not been used to evaluate the dataset node. For example, model node 415 and dataset node 405a are not connected by an edge.

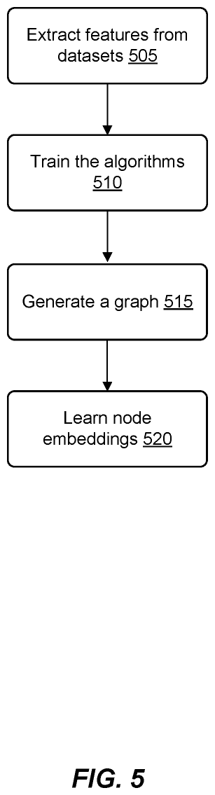

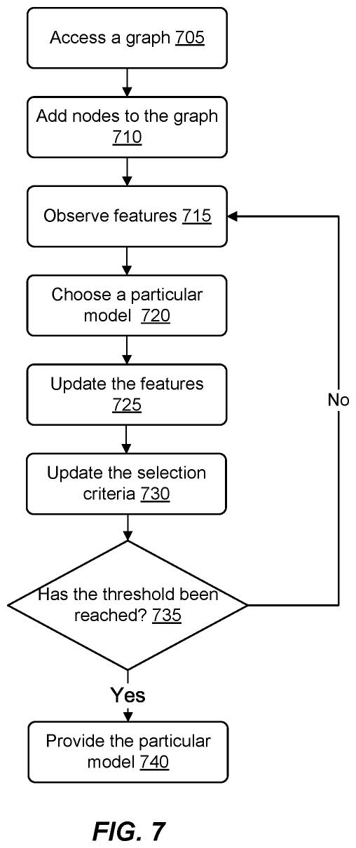

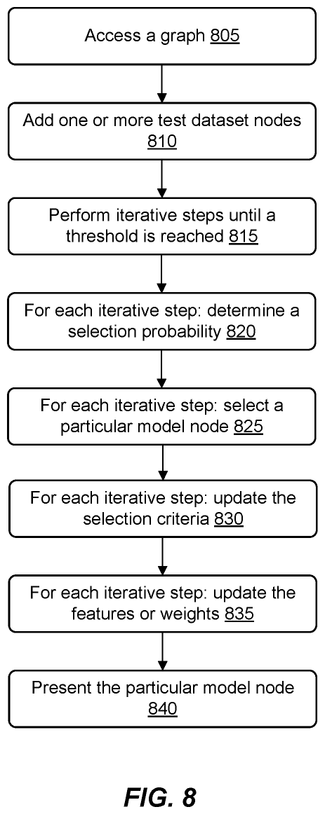

FIG. 5 shows a process 500 for generating a graph according to an embodiment. This process, in addition to the processes of FIG. 7 and the method from FIG. 8, are illustrated as logical flow diagrams, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes or the method.

Turning to process 500 in greater detail, at block 505, features can be extracted from one or more datasets. Feature extraction can be used to prepare the raw data from the dataset for processing. The features can include the data's Shannon entropy, the data's lumpiness and stability, the heterogeneity of time series data, a nonlinearity coefficient for the data, time series features, etc. The features can include the features discussed above with regard to dataset nodes 405a-b. Features can be extracted using Hankel transformation, Lagged convolution, time domain rolling window statistics, frequency domain rolling window coefficients, time-frequency domain rolling window statistics, etc. The features can be selected by correlation, using chi-squared (Ch\hat{ }2), linear regression, random forest feature selection, Boruta feature selection, etc. Dimensionality reduction can be performed using principal component analysis (PCA), singular value decomposition (SVD), or a neural network (e.g., autoencoder).

At block 510, algorithms can be trained to produce models. The algorithms can be trained on the one or more datasets. The hyperparameters for the algorithms can be determined using grid search, random search, Bayesian optimization, etc. A weight, or metric, can created for a model. The weight can represent the model's performance in evaluating a dataset. One model can have more than one weight if the model was used to evaluate more than one dataset. The weight can be the root-mean-square deviation (RMSD) or root-mean-square error (RMSE).

AT block 515, a graph can be generated. The graph can be a graph neural network (GNN). The graph can include one or more model nodes, or model vertexes, representing one or more models. The model nodes can represent a model and the model's hyperparameters. The hyperparameters can be identified using grid search, random search, Bayesian optimization etc. The model nodes can be similar to model node 415 discussed above in relation to FIG. 4. The graph can include one or more dataset nodes, or dataset vertexes, representing one or more datasets. The datasets can be the datasets used to train the algorithms into models. The dataset nodes can be similar to dataset nodes 405a-b discussed above in relation to FIG. 4.

The graph can include edges. The dataset nodes can be connected by edges and one edge can connect two dataset nodes. A similarity metric can be calculated for pairs of datasets. The similarity metric can represent the similarity of the datasets in the pair of datasets. The similarity metric can be determined based at least in part on the features extracted from the datasets. An edge connecting two dataset nodes can be similar to edge 410a discussed above in relation to FIG. 4. A dataset node and a model node can be connected by an edge. In some circumstances, a dataset node and a model node are connected by an edge if the model represented by the model node was used to evaluate the dataset represented by the dataset node. An edge connecting a dataset node and a model node can include a weight or metric representing the performance of the model, represented by the model node, in evaluating the dataset, represented by the dataset node. Edges connecting a dataset node and a model node can be similar to edge 410b discussed above in relation to FIG. 4.

At block 520, the embeddings for the graph can be learned. The embeddings can be generated via neighbor aggregation. The embeddings can be learned using an algorithm such as HinSAGE or GraphSAGE. An embedding can be a vector representing information about a node in the graph.

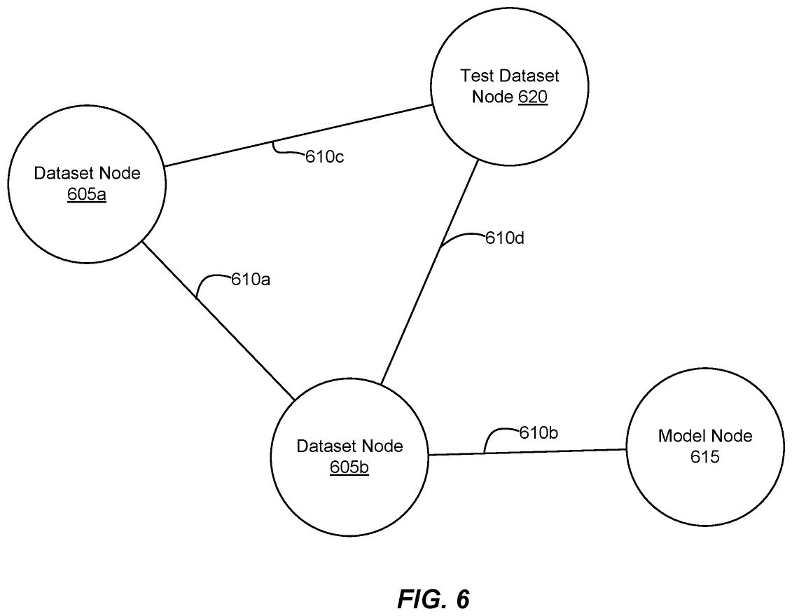

FIG. 6 is a simplified graph 600 with a test dataset node according to an embodiment. The graph can contain dataset nodes, such as dataset nodes 605a-b, that are similar to dataset nodes 405a-b discussed above in relation to FIG. 4. Dataset nodes 605a-b can be connected by edge 610a that is similar to edge 410a discussed above in relation to FIG. 4. The graph can include model nodes, such as model node 615, and the model nodes can be similar to model node 415 discussed above in relation to FIG. 4. A model node and a dataset node can be connected by an edge. The edge connecting a dataset node and a model node can be similar to edge 410b described above in relation to FIG. 4.

Simplified graph 600 can include a test dataset node 620. The graph can be used to recommend a model that can be used to evaluate the data represented by test dataset node 620. The data represented by test dataset node 620 can be data that has not been evaluated by a model represented by a model node (e.g., model node 615). Test dataset node 620 can be connected by an edge to a dataset node. For example, test dataset node 620 can be connected by an edge 610c to test dataset node 605a. Test dataset node 620 can also be connected to dataset node 605b by edge 610d. In some circumstances, the test dataset nodes are not connected by edges to the model nodes.

Edges connecting test dataset nodes to dataset nodes can have a weight, or metric, representing the similarity between the datasets represented by the connected nodes. For example, edge 610c can have a weight representing the similarity of the test dataset, represented by test dataset node 620, and a dataset, represented by dataset node 605a. Test dataset nodes, such as test dataset node 620, can be connected by an edge to every dataset node in the graph.

The weights, or metrics, in the edge can be used to suggest a model, for example the model represented by model node 615, for a test dataset, such as the dataset represented by test dataset node 620. Edge 610d connecting dataset node 605b and test dataset node 620 contains a weight indicating the similarity between the dataset, represented by dataset node 605b, and the test dataset, represented by test dataset node 620. Edge 610b connecting model node 615 and dataset node 605b includes a weight indicating the model's performance in evaluating the dataset. In some circumstances, a model's performance on a dataset can be used to predict the model's performance on a similar dataset. The weights in the edges, e.g., edge 610b and edge 610d, connecting a model node, e.g., model node 615, and a test dataset node, e.g., test dataset node 620, can be used to predict the model's performance evaluating the test dataset.

FIG. 7 is a process 700 for recommending a model to evaluate a dataset according to an embodiment. Various recommenders are contemplated and a content-based recommender, such as a recommender using a k-nearest neighbor (KNN) algorithm, can recommend models and hyperparameters using the graph database. A popularity recommender could recommend the most popular model and hyperparameters by sorting. Collaborative recommenders can be used to recommend models that are commonly selected together. A collaborative recommender can use the apriori algorithm, singular value decomposition (SVD), matrix factorization, alternating least square, etc. A hybrid recommender can also be used to recommend a model and hyperparameters. A hybrid recommender combines the features of content based recommenders, popularity recommenders, and collaborative recommenders. A hybrid recommender could us a wide and deep learning model or a contextual bandit using an upper-confidence-bound (UCB) algorithm with Thompson sampling.

Turning to process 700 in greater detail, at block 705 a graph is accessed. The graph can be accessed after the graph is generated according to the process 500 described above.

At block 710, one or more nodes can be added to the graph. The one or more added nodes can be a test dataset node such as test dataset node 620. The one or more nodes can be added to the graph by connecting the one or more added nodes to existing nodes in the graph. The existing nodes can be dataset nodes such as dataset node 605a. The one or more added nodes and one or more existing nodes can be connected via edges such as edges 610c-d.

At block 715, the features in the graph can be observed. The features can be observed using an embedding framework, such as a framework for inductive representation learning on large graphs (e.g., GraphSAGE, HinSAGE, etc.). The learned embeddings generated by the embedding framework can be used as features. The model nodes can include features and the dataset nodes can include features. The features for a dataset can include the data's Shannon entropy, the data's lumpiness and stability, the heterogeneity of time series data, a nonlinearity coefficient for the data, time series features, etc. The dataset node features can also include the size of the data in the dataset, the domain of the data in the dataset, and latent or statistical features (e.g., mean, mode, Fourier, wavelet, change points, Seasonal Trend decomposition using Loess (STL), etc.) The features for a model can include the model type, the model family, the values for one or more hyperparameters etc.

At block 720, a model can be chosen. The model can be a parametric model, a non-parametric model, a discriminative model, a generative models, etc. The model can be one of the models represented by a model node (e.g., model node 415). The model can be chosen using a selection probability.

At block 725, the features are updated. An affine transformation can be used to update the features.

At block 730, the selection criteria are updated. The selection criteria can be based at least in part on an objective function. In some circumstances the objective function can be a loss function (e.g., cost function). In some circumstances, the objective function can be a utility function (e.g., reward function, profit function, fitness function, etc.).

At decision step 735, whether the threshold has been reached is determined. If the threshold has not been reached, the process returns to block 715 and the features in the graph are observed. If the threshold has been reached, the process advances to block 740. The threshold can include a time limit for the search. The threshold can also include a limit on the amount of central processing unit (CPU) resources or random access memory (RAM) resources that can be used in the search.

At block 740, the particular model is provided. The particular model can be provided via a user interface (UI).

FIG. 8 shows a method 800 for recommending a model to evaluate a dataset according to an embodiment.

At block 805, a graph can be accessed. The graph can comprise one or more model nodes. The one or more model nodes can be connected by one or more edges. The model nodes can include features. The features can include the model type, the model family, the values for one or more hyperparameters etc. The dataset nodes can include features. The dataset node features can include the size of the data in the dataset, the domain of the data in the dataset, and latent or statistical features (e.g., mean, mode, Fourier, wavelet, change points, Seasonal Trend decomposition using Loess (STL), kurtosis, quantiles, absolute energy, binned entropy, etc.) A model node and a dataset node can be connected by a model edge if the model, represented by the model node, has been used to evaluate the dataset represented by the dataset node. The model edge can include a selection weight. The selection weight can be based at least in part on selection criteria discussed in relation to block 830 below. An edge can also connect two dataset nodes. The edge connecting two dataset nodes can include a similarity weight indicating the similarity between the datasets represented by the dataset nodes.

At block 810, one or more test dataset nodes can be added to the graph. The test dataset nodes can be connected by one or more test edges. The test edges can connect the test dataset node to one or more dataset nodes in the graph. The test edge can include a similarity weight and adding the test dataset nodes can include determining a similarity weight for the nodes connected by a test edge.

At block 815, iterative steps can be performed until a threshold has been reached. The threshold can be a time period. In some circumstances, the threshold can be a central processing unit (CPU) allocation. In some circumstances, the threshold can be a random access memory (RAM) allocation.

At block 820, for each iterative step, a selection probability can be determined. The selection probability can be based at least in part on the selection weight from block 805. The selection probability can be based at least in part on the selection criteria discussed below in relation to block 830.

At block 825, for each iterative step, a particular model node can be selected. The model node can be selected based at least in part on the selection probability from block 820.

At block 830, for each iterative step, the selection criteria can be updated. The selection criteria can include a root means square error (RMSE) that is calculated for at least a subset of the models represented by the model nodes. The selected model can be the model with the lowest RMSE score. In some circumstances, the selection criteria can include a F1 score. The selected model can be the model with the highest F1 score. The selection criteria can be the results of an objective function that is calculated for at least a subset of the models represented by the model nodes. The selected model can be the model that produces an optimized value for the objective function.

At block 835, for each iterative step, the features or weights can be updated. The weights can include a plurality of hyperparameters.

At block 840, the particular model node can be presented. The model node can be presented via a user interface (UI).

Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more security group rules provisioned to define how the security of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

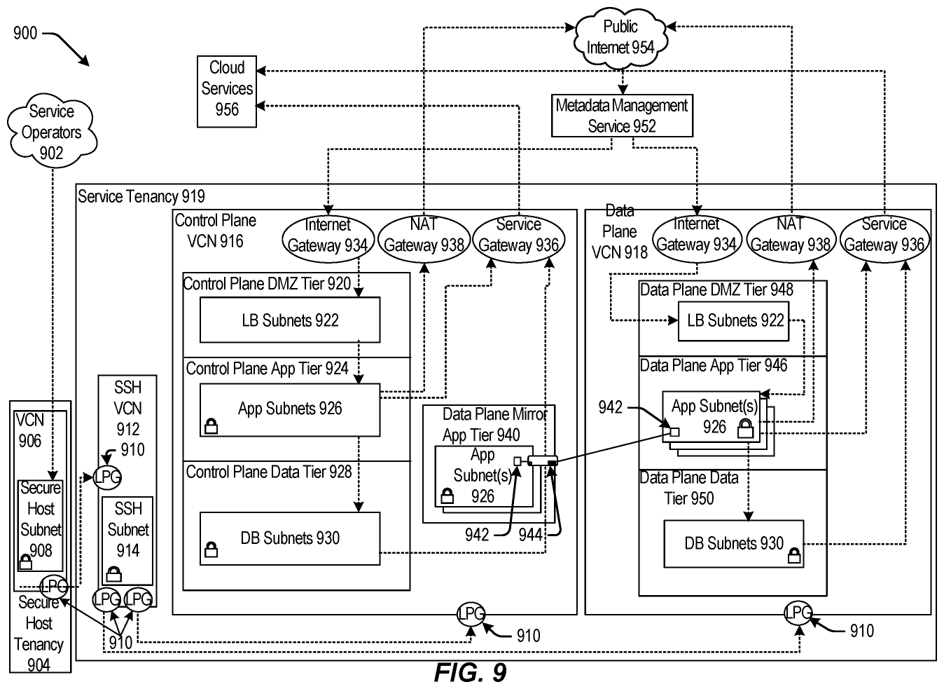

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep security breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively couple to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Memory that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of security, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

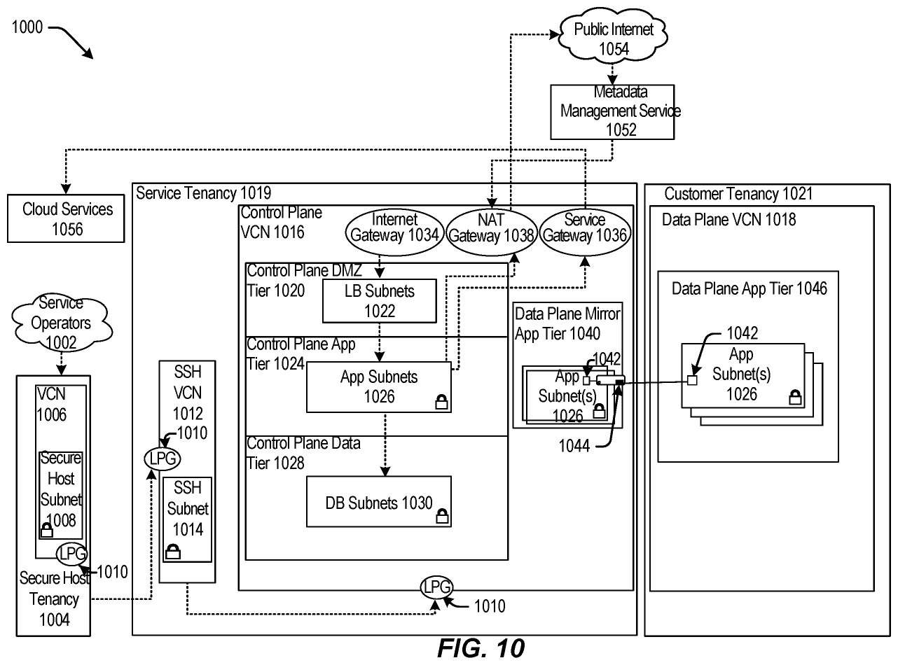

FIG. 10 is a block diagram 1000 illustrating another example pattern of an IaaS architecture, according to at least one embodiment. Service operators 1002 (e.g. service operators 902 of FIG. 9) can be communicatively coupled to a secure host tenancy 1004 (e.g. the secure host tenancy 904 of FIG. 9) that can include a virtual cloud network (VCN) 1006 (e.g. the VCN 906 of FIG. 9) and a secure host subnet 1008 (e.g. the secure host subnet 908 of FIG. 9). The VCN 1006 can include a local peering gateway (LPG) 1010 (e.g. the LPG 910 of FIG. 9) that can be communicatively coupled to a secure shell (SSH) VCN 1012 (e.g. the SSH VCN 912 of FIG. 9) via an LPG 910 contained in the SSH VCN 1012. The SSH VCN 1012 can include an SSH subnet 1014 (e.g. the SSH subnet 914 of FIG. 9), and the SSH VCN 1012 can be communicatively coupled to a control plane VCN 1016 (e.g. the control plane VCN 916 of FIG. 9) via an LPG 1010 contained in the control plane VCN 1016. The control plane VCN 1016 can be contained in a service tenancy 1019 (e.g. the service tenancy 919 of FIG. 9), and the data plane VCN 1018 (e.g. the data plane VCN 918 of FIG. 9) can be contained in a customer tenancy 1021 that may be owned or operated by users, or customers, of the system.

The control plane VCN 1016 can include a control plane DMZ tier 1020 (e.g. the control plane DMZ tier 920 of FIG. 9) that can include LB subnet(s) 1022 (e.g. LB subnet(s) 922 of FIG. 9), a control plane app tier 1024 (e.g. the control plane app tier 924 of FIG. 9) that can include app subnet(s) 1026 (e.g. app subnet(s) 926 of FIG. 9), a control plane data tier 1028 (e.g. the control plane data tier 928 of FIG. 9) that can include database (DB) subnet(s) 1030 (e.g. similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g. the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g. the service gateway of FIG. 9) and a network address translation (NAT) gateway 1038 (e.g. the NAT gateway 938 of FIG. 9). The control plane VCN 1016 can include the service gateway 1036 and the NAT gateway 1038.

The control plane VCN 1016 can include a data plane mirror app tier 1040 (e.g. the data plane mirror app tier 940 of FIG. 9) that can include app subnet(s) 1026. The app subnet(s) 1026 contained in the data plane mirror app tier 1040 can include a virtual network interface controller (VNIC) 1042 (e.g. the VNIC of 942) that can execute a compute instance 1044 (e.g. similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g. the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g. the metadata management service 952 of FIG. 9) that can be communicatively coupled to public Internet 1054 (e.g. public Internet 954 of FIG. 9). Public Internet 1054 can be communicatively coupled to the NAT gateway 1038 contained in the control plane VCN 1016. The service gateway 1036 contained in the control plane VCN 1016 can be communicatively couple to cloud services 1056 (e.g. cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

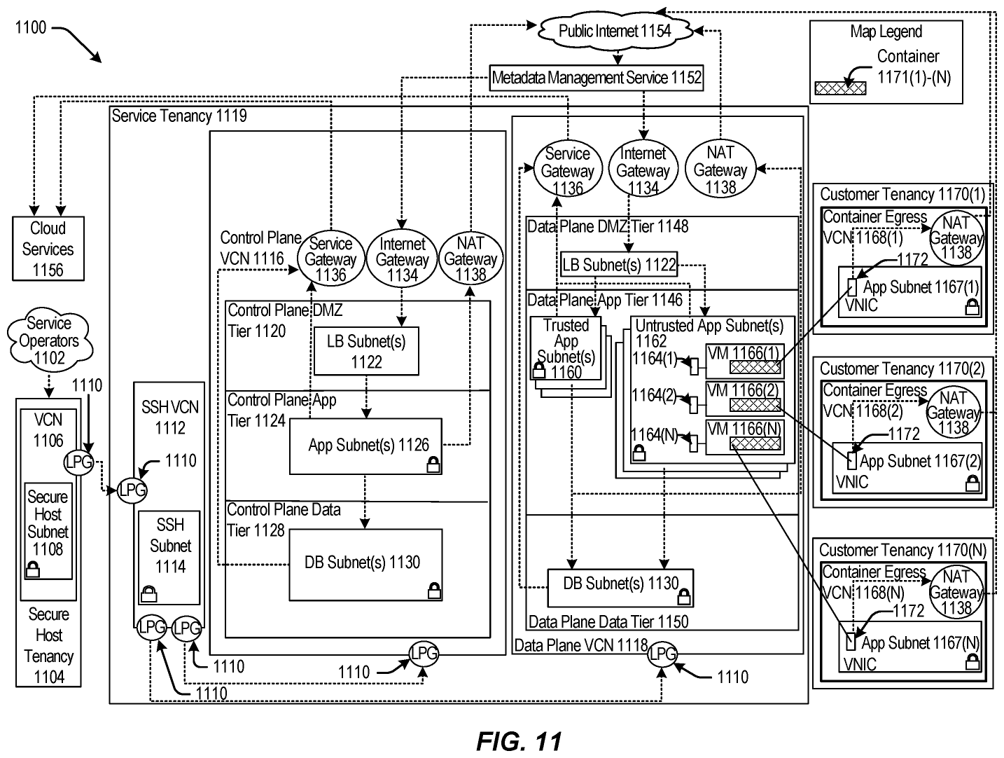

FIG. 11 is a block diagram 1100 illustrating another example pattern of an IaaS architecture, according to at least one embodiment. Service operators 1102 (e.g. service operators 902 of FIG. 9) can be communicatively coupled to a secure host tenancy 1104 (e.g. the secure host tenancy 904 of FIG. 9) that can include a virtual cloud network (VCN) 1106 (e.g. the VCN 906 of FIG. 9) and a secure host subnet 1108 (e.g. the secure host subnet 908 of FIG. 9). The VCN 1106 can include an LPG 1110 (e.g. the LPG 910 of FIG. 9) that can be communicatively coupled to an SSH VCN 1112 (e.g. the SSH VCN 912 of FIG. 9) via an LPG 1110 contained in the SSH VCN 1112. The SSH VCN 1112 can include an SSH subnet 1114 (e.g. the SSH subnet 914 of FIG. 9), and the SSH VCN 1112 can be communicatively coupled to a control plane VCN 1116 (e.g. the control plane VCN 916 of FIG. 9) via an LPG 1110 contained in the control plane VCN 1116 and to a data plane VCN 1118 (e.g. the data plane 918 of FIG. 9) via an LPG 1110 contained in the data plane VCN 1118. The control plane VCN 1116 and the data plane VCN 1118 can be contained in a service tenancy 1119 (e.g. the service tenancy 919 of FIG. 9).

The control plane VCN 1116 can include a control plane DMZ tier 1120 (e.g. the control plane DMZ tier 920 of FIG. 9) that can include load balancer (LB) subnet(s) 1122 (e.g. LB subnet(s) 922 of FIG. 9), a control plane app tier 1124 (e.g. the control plane app tier 924 of FIG. 9) that can include app subnet(s) 1126 (e.g. similar to app subnet(s) 926 of FIG. 9), a control plane data tier 1128 (e.g. the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g. the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g. the service gateway of FIG. 9) and a network address translation (NAT) gateway 1138 (e.g. the NAT gateway 938 of FIG. 9). The control plane VCN 1116 can include the service gateway 1136 and the NAT gateway 1138.

The data plane VCN 1118 can include a data plane app tier 1146 (e.g. the data plane app tier 946 of FIG. 9), a data plane DMZ tier 1148 (e.g. the data plane DMZ tier 948 of FIG. 9), and a data plane data tier 1150 (e.g. the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g. public Internet 954 of FIG. 9).

The Internet gateway 1134 contained in the control plane VCN 1116 and contained in the data plane VCN 1118 can be communicatively coupled to a metadata management service 1152 (e.g. the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

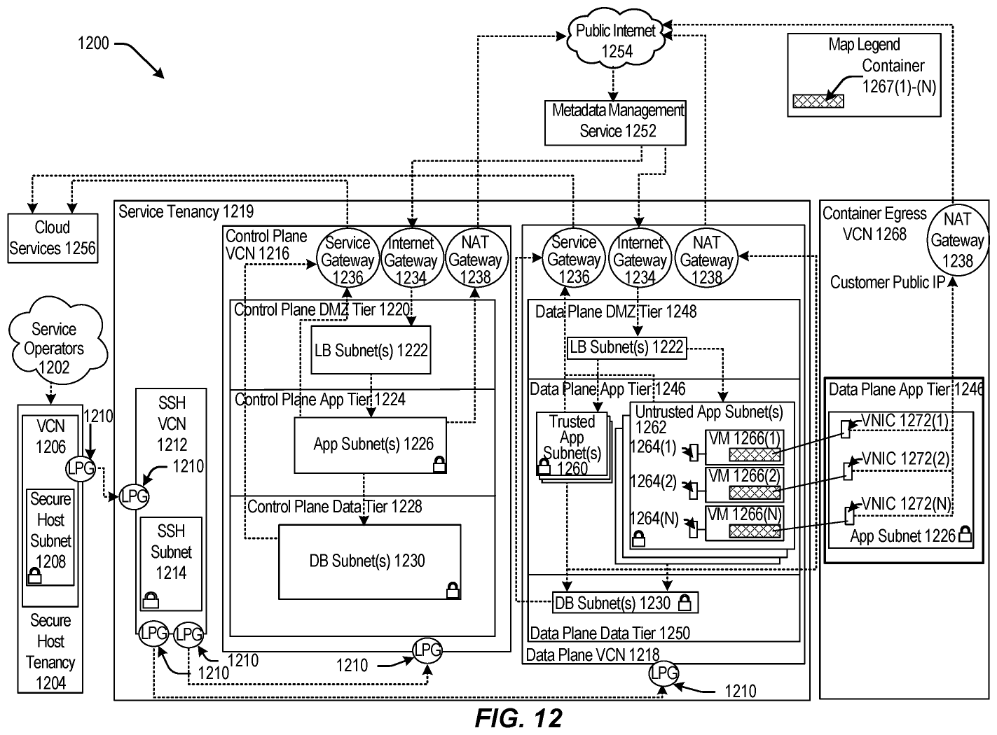

FIG. 12 is a block diagram 1200 illustrating another example pattern of an IaaS architecture, according to at least one embodiment. Service operators 1202 (e.g. service operators 902 of FIG. 9) can be communicatively coupled to a secure host tenancy 1204 (e.g. the secure host tenancy 904 of FIG. 9) that can include a virtual cloud network (VCN) 1206 (e.g. the VCN 906 of FIG. 9) and a secure host subnet 1208 (e.g. the secure host subnet 908 of FIG. 9). The VCN 1206 can include an LPG 1210 (e.g. the LPG 910 of FIG. 9) that can be communicatively coupled to an SSH VCN 1212 (e.g. the SSH VCN 912 of FIG. 9) via an LPG 1210 contained in the SSH VCN 1212. The SSH VCN 1212 can include an SSH subnet 1214 (e.g. the SSH subnet 914 of FIG. 9), and the SSH VCN 1212 can be communicatively coupled to a control plane VCN 1216 (e.g. the control plane VCN 916 of FIG. 9) via an LPG 1210 contained in the control plane VCN 1216 and to a data plane VCN 1218 (e.g. the data plane 918 of FIG. 9) via an LPG 1210 contained in the data plane VCN 1218. The control plane VCN 1216 and the data plane VCN 1218 can be contained in a service tenancy 1219 (e.g. the service tenancy 919 of FIG. 9).

The control plane VCN 1216 can include a control plane DMZ tier 1220 (e.g. the control plane DMZ tier 920 of FIG. 9) that can include LB subnet(s) 1222 (e.g. LB subnet(s) 922 of FIG. 9), a control plane app tier 1224 (e.g. the control plane app tier 924 of FIG. 9) that can include app subnet(s) 1226 (e.g. app subnet(s) 926 of FIG. 9), a control plane data tier 1228 (e.g. the control plane data tier 928 of FIG. 9) that can include DB subnet(s) 1230 (e.g. DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g. the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g. the service gateway of FIG. 9) and a network address translation (NAT) gateway 1238 (e.g. the NAT gateway 938 of FIG. 9). The control plane VCN 1216 can include the service gateway 1236 and the NAT gateway 1238.

The data plane VCN 1218 can include a data plane app tier 1246 (e.g. the data plane app tier 946 of FIG. 9), a data plane DMZ tier 1248 (e.g. the data plane DMZ tier 948 of FIG. 9), and a data plane data tier 1250 (e.g. the data plane data tier 950 of FIG. 9). The data plane DMZ tier 1248 can include LB subnet(s) 1222 that can be communicatively coupled to trusted app subnet(s) 1260 (e.g. trusted app subnet(s) 1160 of FIG. 11) and untrusted app subnet(s) 1262 (e.g. untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g. public Internet 954 of FIG. 9).

The Internet gateway 1234 contained in the control plane VCN 1216 and contained in the data plane VCN 1218 can be communicatively coupled to a metadata management service 1252 (e.g. the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively couple to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

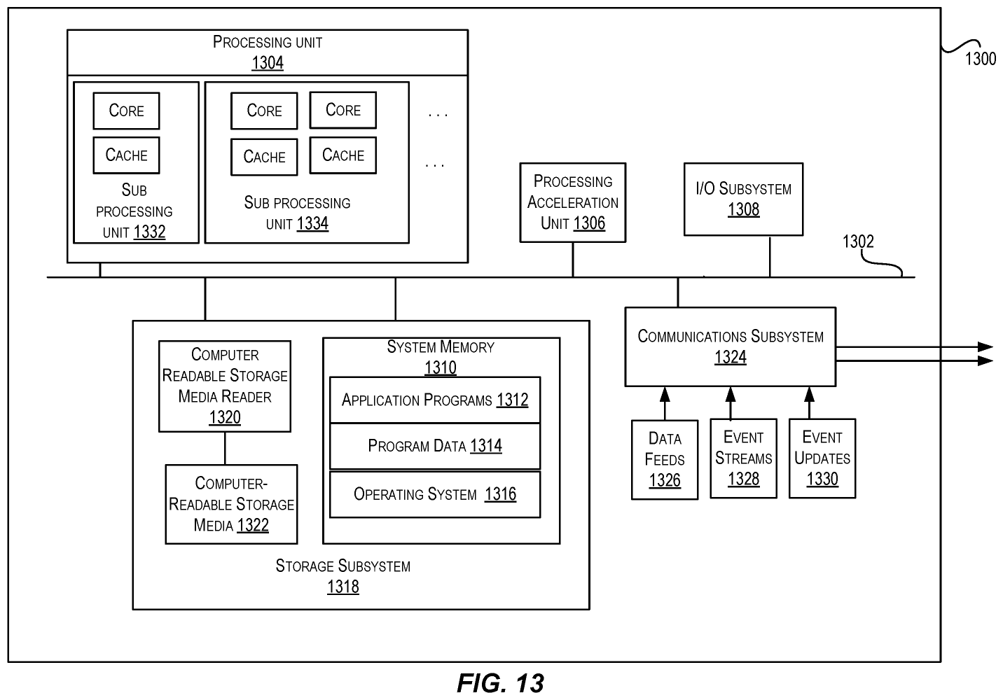

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that comprises software elements, shown as being currently located within a system memory 1310. System memory 1310 may store program instructions that are loadable and executable on processing unit 1304, as well as data generated during the execution of these programs.

Depending on the configuration and type of computer system 1300, system memory 1310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1304. In some implementations, system memory 1310 may include multiple different types of memory, such as static random access memory (SRAM) or dynamic random access memory (DRAM). In some implementations, a basic input/output system (BIOS), containing the basic routines that help to transfer information between elements within computer system 1300, such as during start-up, may typically be stored in the ROM. By way of example, and not limitation, system memory 1310 also illustrates application programs 1312, which may include client applications, Web browsers, mid-tier applications, relational database management systems (RDBMS), etc., program data 1314, and an operating system 1316. By way of example, operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 13 OS, and Palm® OS operating systems.

Storage subsystem 1318 may also provide a tangible computer-readable storage medium for storing the basic programming and data constructs that provide the functionality of some embodiments. Software (programs, code modules, instructions) that when executed by a processor provide the functionality described above may be stored in storage subsystem 1318. These software modules or instructions may be executed by processing unit 1304. Storage subsystem 1318 may also provide a repository for storing data used in accordance with the present disclosure.

Storage subsystem 1300 may also include a computer-readable storage media reader 1320 that can further be connected to computer-readable storage media 1322. Together and, optionally, in combination with system memory 1310, computer-readable storage media 1322 may comprehensively represent remote, local, fixed, and/or removable storage devices plus storage media for temporarily and/or more permanently containing, storing, transmitting, and retrieving computer-readable information.

Computer-readable storage media 1322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1300.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
accessing, by a computing device, a graph comprising one or more model nodes, one or more dataset nodes, and one or more edges, the one or more model nodes having at least one of a plurality of features or a plurality of weights;
adding, by a computing device, one or more test dataset nodes and one or more test edges to the graph;
performing, by the computing device, a series of iterative steps until a threshold is reached;
for each iterative step:
determining, by the computing device, a selection probability for each model node, the selection probability being based at least in part on a plurality of selection criteria;
selecting, by the computing device, a particular model node, the particular model node being selected based at least in part on the selection probability;
updating, by the computer device, the selection criteria based at least in part on the particular model; and
updating, by the computer device, at least one of the plurality of features or the plurality of weights based at least in part on the particular model; and
providing, by the computer device, the selected particular model node for the last iterative step in the series of iterative steps for presentation.

2. The method of claim 1, wherein the plurality of features comprise a plurality of hyperparameters.

3. The method of claim 1, wherein the threshold can be at least one of a time period, a central processing unit (CPU) allocation, or a random access memory (RAM) allocation.

4. The method of claim 1, wherein a model node, from the one or more model nodes, and a first dataset node, from the one or more dataset nodes, are connected by a model edge, of the one or more edges, in accordance with the dataset having been evaluated by the model.

5. The method of claim 4, wherein the model edge has a selection weight, the selection criteria being based at least in part on the selection weight.

6. The method of claim 4, wherein a dataset edge, from the one or more edges, connecting the first dataset node and a second dataset node, from the one or more dataset nodes, has a similarity weight indicating a similarity between the first dataset node and the second dataset node.

7. The method of claim 6, wherein adding one or more test edges further comprises determining the similarity weight for the one or more test edges.

8. A non-transitory computer-readable storage medium storing a set of instructions, that, when executed by one or more processors of a recommendation system computing device, cause the one or more processors to perform instructions comprising:
accessing a graph comprising one or more model nodes, one or more dataset nodes, and one or more edges, the one or more model nodes having at least one of a plurality of features or a plurality of weights;
adding one or more test dataset nodes and one or more test edges to the graph;
performing a series of iterative steps until a threshold is reached;
for each iterative step:
determining a selection probability for each model node, the selection probability being based at least in part on a plurality of selection criteria;
selecting a particular model node, the particular model node being selected based at least in part on the selection probability;
updating the selection criteria based at least in part on the particular model; and
updating at least one of the plurality of features or the plurality of weights based at least in part on the particular model; and
providing the selected particular model node for the last iterative step in the series of iterative steps for presentation.

9. The non-transitory computer-readable storage medium of claim 8, wherein the plurality of features comprise a plurality of hyperparameters.

10. The non-transitory computer-readable storage medium of claim 8, wherein the threshold can be at least one of a time period, a central processing unit (CPU) allocation, or a random access memory (RAM) allocation.

11. The non-transitory computer-readable storage medium of claim 8, wherein a model node, from the one or more model nodes, and a first dataset node, from the one or more dataset nodes, are connected by a model edge, of the one or more edges, in accordance with the dataset having been evaluated by the model.

12. The non-transitory computer-readable storage medium of claim 11, wherein the model edge has a selection weight, the selection criteria being based at least in part on the selection weight.

13. The non-transitory computer-readable storage medium of claim 12, wherein a dataset edge, from the one or more edges, connecting the first dataset node and a second dataset node, from the one or more dataset nodes, has a similarity weight indicating a similarity between the first dataset node and the second dataset node.

14. The non-transitory computer-readable storage medium of claim 9, wherein adding one or more test edges further comprises determining the similarity weight for the one or more test edges.

15. A recommendation system, comprising:
memory storing computer-executable instructions; and
one or more processors configured to access the memory, and execute the computer-executable instructions to at least:
access a graph comprising one or more model nodes, one or more dataset nodes, and one or more edges, the one or more model nodes having at least one of a plurality of features or a plurality of weights;
add one or more test dataset nodes and one or more test edges to the graph;
perform a series of iterative steps until a threshold is reached;
for each iterative step:
determine a selection probability for each model node, the selection probability being based at least in part on a plurality of selection criteria;
select a particular model node, the particular model node being selected based at least in part on the selection probability;
update the selection criteria based at least in part on the particular model; and
update at least one of the plurality of features or the plurality of weights based at least in part on the particular model; and
provide the selected particular model node for the last iterative step in the series of iterative steps for presentation.

16. The system of claim 11, wherein the plurality of features comprise a plurality of hyperparameters.

17. The system of claim 11, wherein a model node, from the one or more model nodes, and a first dataset node, from the one or more dataset nodes, are connected by a model edge, of the one or more edges, in accordance with the dataset having been evaluated by the model.

18. The system of claim 13, wherein the model edge has a selection weight, the selection criteria being based at least in part on the selection weight.

19. The system of claim 13, wherein a dataset edge, from the one or more edges, connecting the first dataset node and a second dataset node, from the one or more dataset nodes, has a similarity weight indicating a similarity between the first dataset node and the second dataset node.

20. The system of claim 19, wherein adding one or more test edges further comprises determining the similarity weight for the one or more test edges.
